(19) United States
(12) Patent Application Publication
(10) Pub. No.: US 2008/0165301 A1
(43) Pub. Date: Jul. 10, 2008

(54) LIQUID CRYSTAL DISPLAY PANEL WITH AN ELECTROSTATIC DISCHARGE PROTECTION CAPABILITY

(75) Inventors: Nai-Heng CHANG, Taichung (TW); Chih-Ming CHEN, Fongyuan City (TW); Lin LIN, Taichung City (TW); Chih-Chang LAI, Taiping City (TW); Wen-Chun WANG, Taichung (TW); Shyh-Jeng CHEN, Tanzih Hsiang (TW); Chun Chieh WU, Daliao Hsiang (TW); Chi-Ming HSIEH, Taichung (TW)

Correspondence Address: PATENTTM.US, P. O. BOX 82788, PORTLAND, OR, 97282-0788, US

(73) Assignee: WINTEK CORPORATION, TANZIH HSIANG (TW)

(21) Appl. No.: 11/970,120

(22) Filed: Jan. 7, 2008

(30) Foreign Application Priority Data
Jan. 8, 2007 (TW) 096100659

(51) Int. Cl. G02F 1/1333

(52) U.S. Cl. 349/40

(57) ABSTRACT

A liquid crystal display panel with electrostatic discharge protection capability has an array substrate having an active area, a driver IC, a Vcom wire and an electrostatic reduction element formed on. The driver IC is formed beside the active area. The Vcom wire is formed around the active area and is connected with the electrostatic reduction element to the driver IC. When an electrostatic discharge current flows on the Vcom wire to the driver IC, the electrostatic reduction element mitigates or obviates damage to the driver IC.

### BACKGROUND OF THE INVENTION

1. Field of Invention

The present invention relates to a liquid crystal display panel, and more particularly to a liquid crystal display panel with an electrostatic discharge protection capability.

2. Description of the Related Art

With reference to FIGS. 11 and 12, a liquid crystal display (LCD) panel has a laminated color filter glass substrate, a liquid crystal layer and an array substrate (70). The color filter substrate has a glass substrate, a color filter substrate and a common electrode. The color filter substrate is formed on the glass substrate. The common electrode is transparent, conductive and formed on the color filter substrate.

The array substrate (70) includes a glass substrate (73), a driver IC (71), thin film transistors (TFT), gate lines, data lines, a Vcom wire (72) and electrostatic discharge circuits. The array substrate (70) has an active area (732). The driver IC (71) is mounted on the glass substrate (73) outside the active area (732). The TFTs are formed in a matrix configuration in the active area (732), and each TFT has a gate, a source and a drain. The gate lines are formed transversely on the glass substrate (73) and are connected to the driver IC (71) and to the gates of the TFTs. The data lines are formed longitudinally on the glass substrate (73) and are connected to the driver IC (71) and respectively to the sources of the TFTs. The Vcom wire (72) is a conductive wire, provides a reference voltage for the LCD panel, is formed partially around the active area (732), is connected to the driver IC (71) and is connected to the common electrode.

The electrostatic releasing circuits prevent damage to the driver IC (71) by an electrostatic discharge current in the data lines or gate lines, and each electrostatic releasing circuit includes two common gate transistors (T1, T2). The common gate transistors (T1, T2) are mounted in parallel between the Vcom wire (72) and each of the data lines and each one of the gate lines, so that any electrostatic discharge current on the data lines and gate lines will be diverted to the Vcom wire (72) through the electrostatic releasing circuit.

However, the Vcom wire (72) is connected to the driver IC (71), so the electrostatic discharge current may still damage the driver IC (71).

The present invention provides a liquid crystal display panel with an electrostatic discharge protection capability to obviate or mitigate the shortcomings of the conventional liquid crystal display panel.

### SUMMARY OF THE INVENTION

The primary objective of the present invention is to provide a liquid crystal display panel with an electrostatic discharge protection capability to prevent damage to a driver IC in the liquid crystal display panel by an electrostatic discharge from a Vcom wire also in the liquid crystal display panel.

The liquid crystal display panel with electrostatic discharge protection capability has an array substrate having an active area, a driver IC, a Vcom wire and an electrostatic reduction element. The driver IC is formed outside the active area. The Vcom wire is formed partially around the active area and is connected to the driver IC. When an electrostatic discharge current flows on the Vcom wire to the driver IC, the electrostatic reduction element mitigates or obviates damage to the driver IC.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a liquid crystal display panel with electrostatic discharge protection capability in accordance of the present invention;

FIG. 2 is a top view of an array substrate of the liquid crystal display panel in FIG. 1;

FIG. 3 is a circuit diagram of a resistor connected in series between a driver IC and a Vcom wire of the liquid crystal display panel in FIG. 1;

FIG. 4 is a circuit diagram of a high resistance strip connected in series between the driver IC and the Vcom wire in FIG. 1;

FIG. 5 is an enlarged top view of a grounded parallel strip of the Vcom wire;

FIG. 6 is a circuit diagram of a series inverter circuit connected in series between the Vcom wire and the driver IC;

FIG. 7 is a top view of an external circuit board attached to the array substrate in FIG. 1;

FIG. 8 is an exploded perspective view of a liquid crystal display panel with a bidirectional Transient Voltage Suppressor circuit in accordance of the present invention;

FIG. 9 is an exploded perspective view of a liquid crystal display panel with another bidirectional Transient Voltage Suppressor circuit in accordance of the present invention;

FIG. 10 is an I-V characteristic curve of a bidirectional Transient Voltage Suppressor in FIG. 8;

FIG. 11 is a top view of a conventional array substrate for a liquid crystal display panel in accordance with the prior art; and

FIG. 12 is a circuit diagram of an electrostatic releasing circuit connected in series between multiple gate lines, multiple data lines and a Vcom wire in FIG. 11.

### DETAILED DESCRIPTION OF THE INVENTION

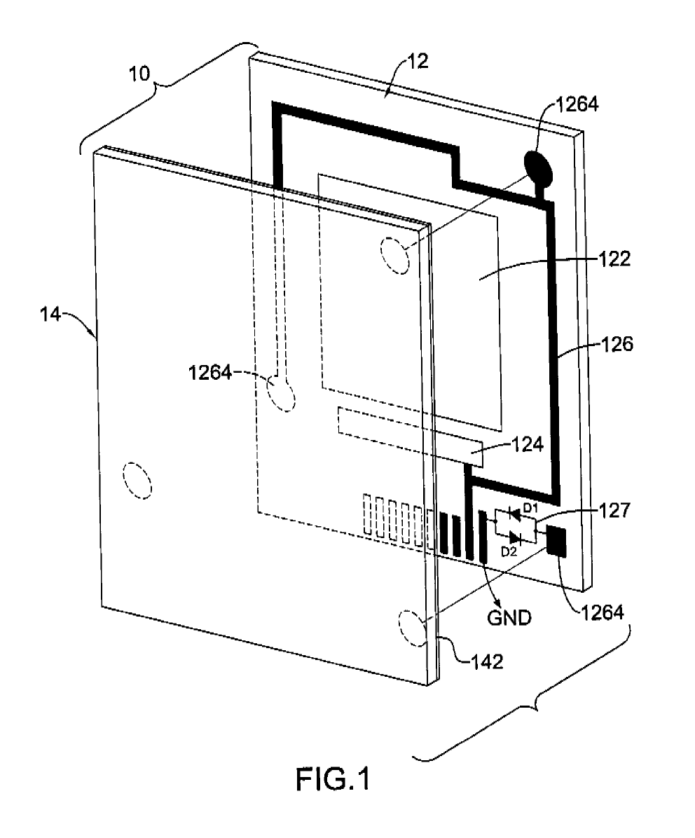

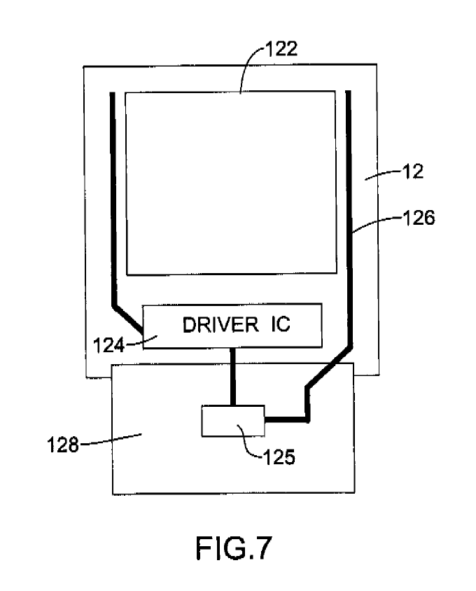

With reference to FIGS. 1, 6 and 7, a liquid crystal display panel (10) with electrostatic discharge protection capability in accordance with the present invention comprises an array substrate (12), a color filter substrate (14) and a liquid crystal layer.

The array substrate (12) has an inner surface, an active area (122), multiple thin film transistors (TFT), an optional extension circuit board (128), a driver integrated circuit (IC) (124), a Vcom wire (126), an electrostatic reduction element (125), a ground pad (GND) and an optional diode circuit (127).

The active area (122) is defined on the inner surface of the array substrate (12).

The TFTs are mounted in a matrix configuration in the active area (122).

The extension circuit board (128) is selected from a group comprising a printed circuit board and a flexible printed circuit board, overlaps and is mounted on the inner surface of the array substrate (12) adjacent to the active area (122) and has an inner surface corresponding to the inner surface of the array substrate (12).

The driver IC (124) is mounted on the inner surface of the array substrate (12) outside the active area (122), is electrically connected to each TFT, drives the TFTs, and has a Vcom pin (1242), a VcomH pin (1244) and a VcomL pin (1246). The Vcom pin (1242) may transmit a DC voltage or a square wave alternating between a VcomH level and a VcomL level. The VcomH level is a voltage level usually in the range of 3˜5.5V. The VcomL level is a voltage level lower than the VcomH level and is usually in the range of −2.5˜1V The VcomH pin (1244) transmits the VcomH level. The VcomL pin (1246) transmits the VcomL level.

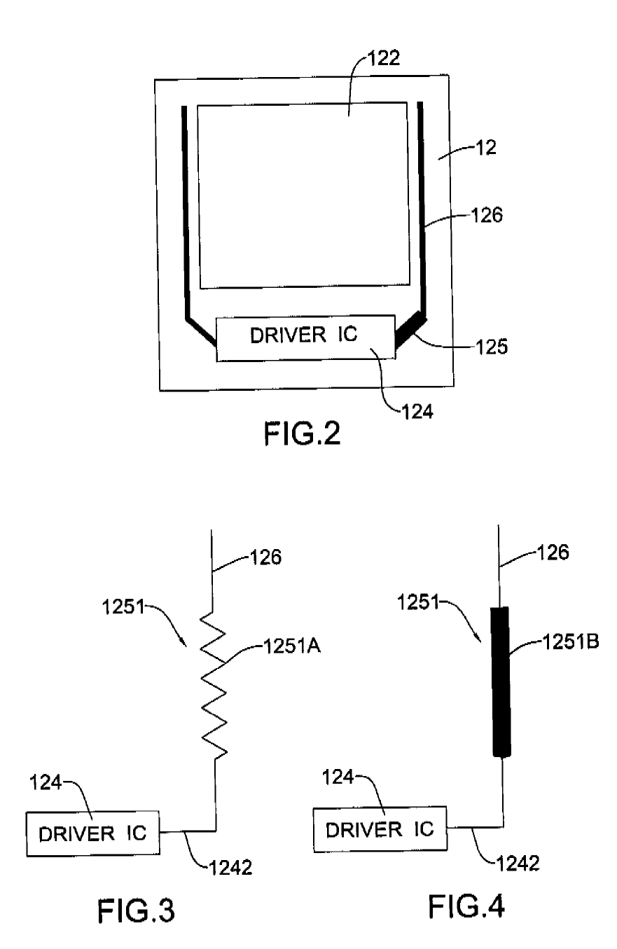

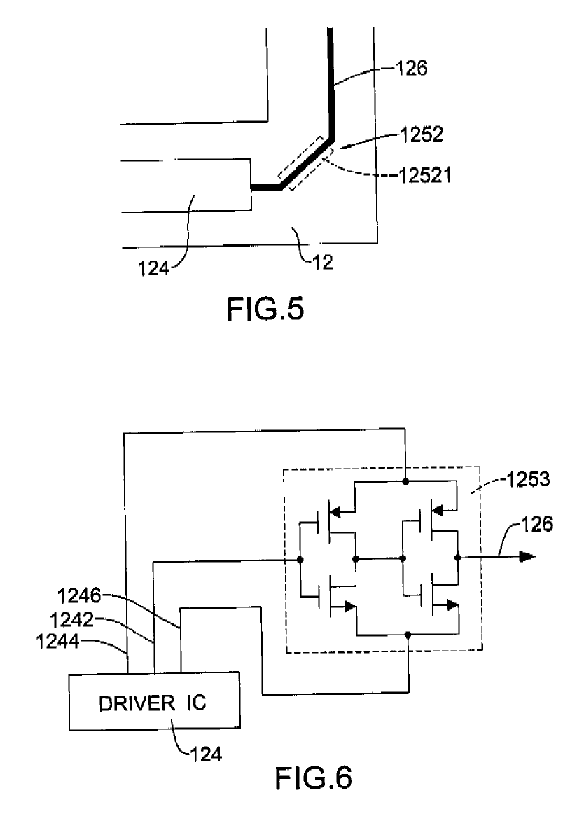

With further reference to FIG. 2, the Vcom wire (126) is formed on the inner surface of the array substrate (12) partially around the active area (122), may be selectively formed on the extension circuit board (128), is electrically connected to the Vcom pin (1242) of the driver IC (124) and has multiple contact pads (1264). The contact pads (1264) are formed on the inner surface of the array substrate (12) and are indirectly or directly connected electrically to the Vcom wire (126).

With further reference to FIGS. 3 and 4, the electrostatic reduction element (125) is mounted adjacent to the driver IC (124), is connected to the Vcom wire (126), may be mounted on the inner surface of the array substrate (12) or the extension circuit board (128), keeps an electrostatic discharge current in the Vcom wire (126) from passing unattenuated directly into the driver IC (124) and may be implemented as a series or a parallel device.

The series device may be a resistive element (1251) or may be a series inverter circuit (1253) being connected in series between the driver IC (124) and the Vcom wire (126). The resistive element (1251) may be implemented with a conventional resistor (1251A), a high resistance strip (1251B) or the like. The resistive element (1251) has higher resistance than that of the Vcom wire(126). Part of the electrostatic discharge current is converted to heat by the resistive element (1251) and is dissipated such that the electrostatic discharge current is significantly reduced. The series inverter circuit (1253) is two complementary metal-oxide-semiconductor (CMOS) inverters and has a signal input, a signal output, a high voltage input and a low voltage input. The signal input is connected electrically to the Vcom pin (1242). The signal output is connected electrically to the Vcom wire (126). The high voltage input is connected electrically to the VcomH pin (1244). The low voltage input is connected to the VcomL pin (1246). Any electrostatic discharge current on the Vcom wire (126) will be attenuated by the series inverter circuit (1253) or will burn out the series inverter circuit (1253) first so the driver IC (124) will not be damaged.

The parallel device acts as a capacitor (1252), is coupled to the Vcom wire (126) adjacent to the driver IC (124) and comprises a parallel grounded pad (12521). The parallel grounded pad (12521) is separately formed above or under the Vcom wire (126) and defines the capacitor between the parallel grounded pad (12521) and the Vcom wire (126). The capacitor increases impedance of the Vcom wire (126) so that part of an electrostatic discharge current through the parallel device is converted to heat and is dissipated such that the electrostatic discharge current is significantly reduced.

The ground pad (GND) is conductive, is formed on the inner surface of the array substrate (12) and connects to a ground. The ground may be an external physical ground or an external reference ground.

The diode circuit (127) is formed on the inner surface of the array substrate (12) and has a first terminal, a second terminal and two diodes (D1, D2). The first terminal of the diode circuit (127) is electrically connected to one of the contact pads (1264). The second terminal of the diode circuit (127) is electrically connected to the ground pad (GND). The diodes (D1, D2) are reversely connected in parallel between the first terminal and the second terminal. The diodes (D1, D2) are used respectively for different flow directions of the electrostatic discharge current. When the electrostatic discharge current flows from the Vcom wire (126) to the ground pad (GND), the diode (D1) is forward biased so that the electrostatic discharge current is directed to the external physical ground through the ground pad (GND). On the other hand, the diode (D2) is forward biased when the electrostatic discharge current flows from the ground pad (GND) to the Vcom wire (126).

The color filter substrate (14) has an inner surface and a transparent common electrode (142). The transparent common electrode (142) is formed on the inner surface of the color filter substrate (14), connects electrically to the multiple contact pads (1264) and provides a conductive path for an electrostatic discharge current from the Vcom wire (126) to the ground pad (GND).

The liquid crystal layer is mounted between the array substrate (12) and the color filter substrate (14).

The liquid crystal display panel as described has the advantages of providing a path for an electrostatic discharge current from the Vcom wire (126) to the ground pad (GND) and mitigating damage to the driver IC (124) by the electrostatic discharge current from the Vcom wire (126).

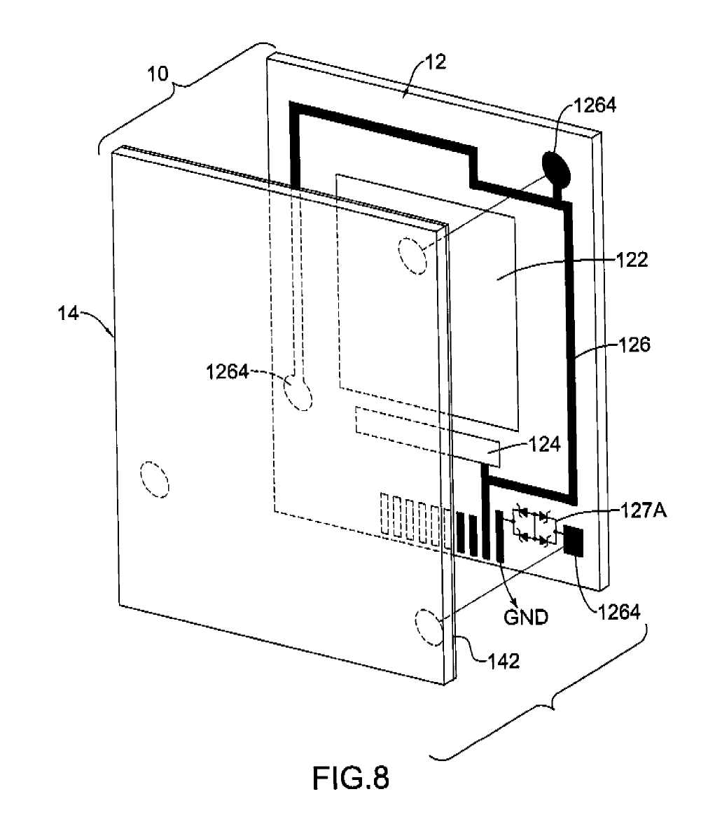

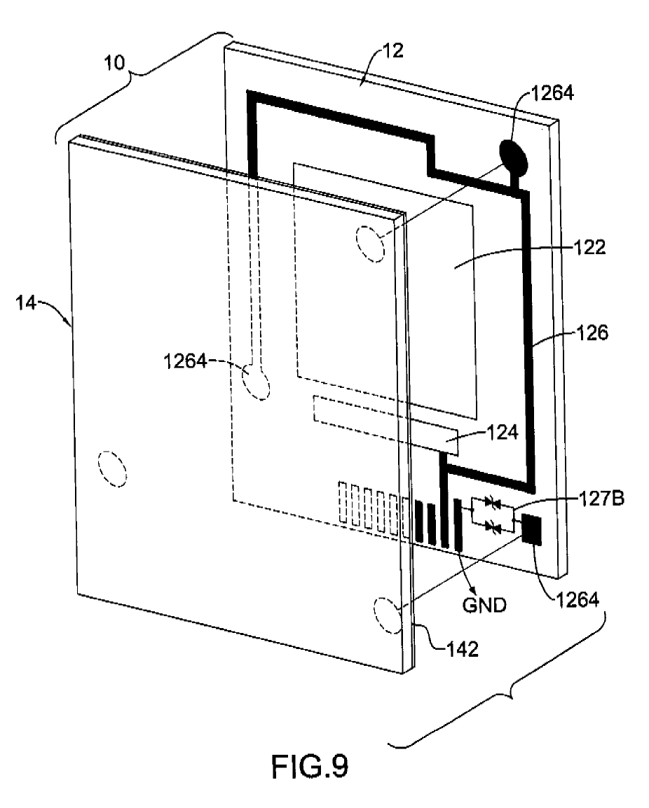

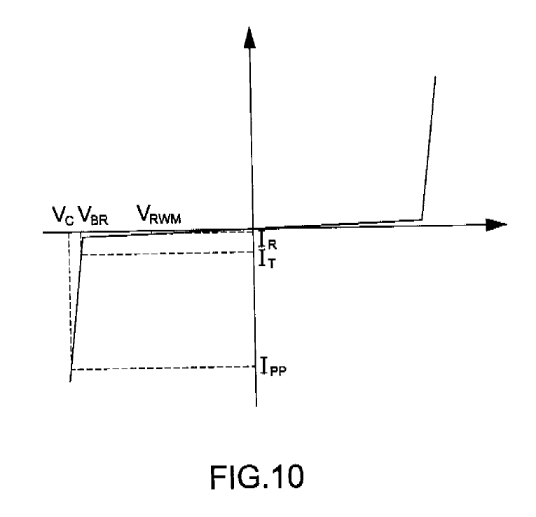

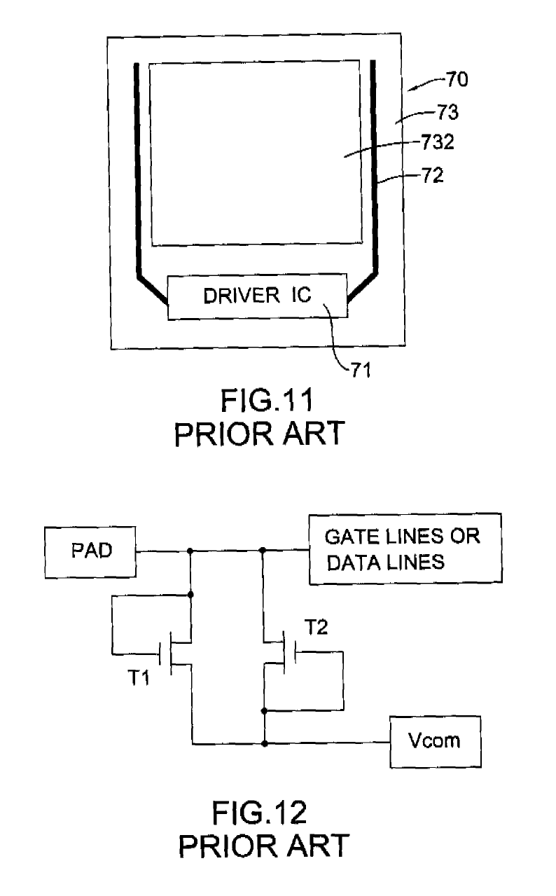

With further reference to FIGS. 8, 9 and 10, the diode circuit (127) shown in FIG. 1 may be replaced by a bidirectional Transient Voltage Suppressor (TVS) circuit (127A, B). The bidirectional TVS circuit (127A, B) has at least one bidirectional TVS being two reversed serial connected diodes. Each bidirectional TVS has an I-V characteristics shown on FIG. 10 such that the electrostatic discharge current is partially suppressed when passing through the bidirectional TVS circuit (127A, B). In FIGS. 8 and 9, showing an equivalent circuit (127A or 127B) composed of two bidirectional TVS (electrostatic reduction elements) and the two bidirectional TVS are connected in parallel to enhance the function of electrostatic discharge. Moreover, the bidirectional TVS circuit (127A, B) can also be provided on the on the extension circuit board (128) instead of on the array substrate (12) to serve as an electrostatic reduction element.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A liquid crystal display panel with electrostatic discharge protection capability comprises:
an array substrate having an active area being defined thereon;
a plurality of thin film transistors (TFT) being formed in a matrix configuration in the active area;
a driver integrated circuit (IC) being mounted on the array substrate outside the active area, being electrically connected to each TFT and driving the TFTs;
a Vcom wire being formed on the array substrate partially around the active area and being electrically connected to the driver IC;
a plurality of contact pads formed on the array substrate and electrically connected to the Vcom wire;
an electrostatic reduction element being provided adjacent to the driver IC, being connected to the Vcom wire, keeping an electrostatic discharge current in the Vcom wire from passing unattenuated directly into the driver IC; and
a ground pad being conductive, being formed on the surface of the array substrate and being connected to a ground;
a color filter substrate having a transparent common electrode formed thereon, connecting electrically to the contact pads and providing a conductive path for an electrostatic discharge current from the Vcom wire to the ground pad; and
a liquid crystal layer interposed between the array substrate and the color filter substrate.

2. The liquid crystal display panel with electrostatic discharge protection capability as claimed in claim 1, wherein the electrostatic reduction element is formed on the array substrate and having
a first terminal electrically connected to one of the contact pads;
a second terminal electrically connected to the ground pad; and
two diodes reversely connected in parallel between the first terminal and the second terminal.

3. The liquid crystal display panel with electrostatic discharge protection capability as claimed in claim 2, wherein at least two of the electrostatic reduction elements are connected in parallel to form an equivalent circuit for electrostatic discharge.

4. The liquid crystal display panel with electrostatic discharge protection capability as claimed in claim 2, comprising an extension circuit board mounted on the partial surface of the array substrate adjacent to the active area and the electrostatic reduction element is provided on the extension circuit board.

5. The liquid crystal display panel with electrostatic discharge protection capability as claimed in claim 1, wherein the electrostatic reduction element is a series device formed on the array substrate and being connected between the Vcom wire and the driver IC.

6. The liquid crystal display panel with electrostatic discharge protection capability as claimed in claim 5, wherein the series device is a conventional resistor and a resistance value of the conventional resistor is higher than that of the Vcom wire.

7. The liquid crystal display panel with electrostatic discharge protection capability as claimed in claim 5, wherein the series device is a high resistance strip.

8. The liquid crystal display panel with electrostatic discharge protection capability as claimed in claim 5, wherein
the driver IC having
a Vcom pin;
a VcomH pin; and
a VcomL pin;
the series device being two complementary metal-oxide-semiconductor (CMOS) inverters and having
a signal input being electrically connected to the Vcom pin;
a signal output being electrically connected to the Vcom wire;
a high voltage input being electrically connected to the VcomH pin; and
a low voltage input being electrically connected to the VcomL pin.

9. The liquid crystal display panel with electrostatic discharge protection capability as claimed in claim 1, wherein the electrostatic reduction element is a parallel device being formed on the array substrate, acting as a capacitor, being connected to the Vcom wire adjacent to the driver IC and comprising a parallel grounded pad isolating formed with the Vcom wire near the driver IC and defining the capacitor increasing an impedance of the Vcom wire near the driver IC.

10. The liquid crystal display panel with electrostatic discharge protection capability as claimed in claim 2, wherein the electrostatic reduction element is a parallel device being formed on the array substrate, acting as a capacitor, being connected to the Vcom wire adjacent to the driver IC and comprising a parallel grounded pad isolating formed with the Vcom wire near the driver IC and defining the capacitor in creasing an impedance of the Vcom wire near the driver IC.

11. The liquid crystal display panel with electrostatic discharge protection capability as claimed in claim 1, wherein the driver IC having a Vcom pin outputting a square wave alternating between a VcomH level being a voltage level and a VcomL level being a voltage level lower than the VcomH level.

12. The liquid crystal display panel with electrostatic discharge protection capability as claimed in claim 1, wherein the driver IC having a Vcom pin outputting a DC voltage.

13. The liquid crystal display panel with electrostatic discharge protection capability as claimed in claim 1, wherein the array substrate further has at least one bidirectional Transient Voltage Suppressor being serially connected between the contact pads and the ground pad.

14. A liquid crystal display panel with electrostatic discharge protection capability comprises:
an array substrate having an active area being defined thereon;
a plurality of thin film transistors (TFT) being formed in a matrix configuration in the active area;
an extension circuit board mounted on the partial surface of the array substrate adjacent to the active area and having an inner surface;
a driver integrated circuit (IC) being mounted on the array substrate outside the active area, being electrically connected to each TFT and driving the TFTs;
a Vcom wire being formed on the array substrate partially around the active area and being electrically connected to the driver IC;
a plurality of contact pads formed on the array substrate and electrically connected to the Vcom wire;
an electrostatic reduction element being provided on the extension circuit board adjacent to the driver IC, being connected to the Vcom wire, keeping an electrostatic discharge current in the Vcom wire from passing unattenuated directly into the driver IC;
a ground pad being conductive, being formed on the array substrate or on the extension circuit board and being connected to a ground;
a color filter substrate having a transparent common electrode formed thereon, connecting electrically to the contact pads and providing a conductive path for an electrostatic discharge current from the Vcom wire to the ground pad; and
a liquid crystal layer interposed between the array substrate and the color filter substrate.

15. The liquid crystal display panel with electrostatic discharge protection capability as claimed in claim 14, wherein the electrostatic reduction element is a series device being formed on the inner surface of the extension circuit board and being connected between the Vcom wire and the driver IC.

16. The liquid crystal display panel with electrostatic discharge protection capability as claimed in claim 15, wherein the extension circuit board is selected from a group comprising a printed circuit board or a flexible printed circuit board.

17. The liquid crystal display panel with electrostatic discharge protection capability as claimed in claim 14, wherein the electrostatic reduction element is a bidirectional Transient Voltage Suppressor being serially connected between the contact pads and the ground pad.
